(19) United States
(12) Patent Application Publication
(10) Pub. No.: US 2005/0245340 A1
(43) Pub. Date: Nov. 3, 2005

(54) Power transmission belt and method of making same

(76) Inventors: Ulrich Ballhausen, Bad Driburg (DE); Ali Amash, (US)

Correspondence Address: ROBERT W. BECKER & ASSOCIATES, 707 HIGHWAY 66 EAST, SUITE B, TIJERAS, NM, 87059, US

(21) Appl. No.: 11/121,297

(22) Filed: May 3, 2005

(30) Foreign Application Priority Data
May 3, 2004 (DE) 10 2004 021 524.3

(51) Int. Cl. F16G 1/00; F16G 5/00

(52) U.S. Cl. 474/266; 474/237; 474/265

(57) ABSTRACT

A power transmission belt of elastomeric material and method of making same, wherein a load-carrying section and a plurality of fabric plies are disposed in the elastomeric material. Each ply is disposed on a rubber type embedment sheet or is embedded in a rubber type matrix. Each ply is composed of filaments crossing in a woven manner. A first group of filaments are oriented essentially transverse to the running direction of the belt, form weft filaments, and are of a material having a high strength, high resistance to bending and high resistance to temperature. A second group of filaments are oriented in the running direction, form warp filaments, and are of a material that has a lower strength and resistance to temperature than the first material.

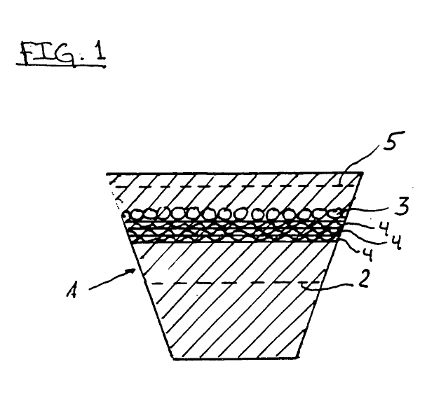

The instant application should be granted the priority date of May 3, 2004, the filing date of the corresponding German patent application 10 2004 021 524.3.

### BACKGROUND OF THE INVENTION

The present invention relates to power transmission belts, especially in the form of power bands, V belts, ribbed V belts, wide V belts, and the like, and also relates to a method of making such power transmission belts.

Such power transmission belts are generally comprised of elastomeric material into which are introduced a load-carrying section and, to achieve a transverse rigidity of the belt, a plurality of fabric plies that are preferably composed of filaments that cross in a woven-like manner. The fabric plies are generally placed upon a rubber-like embedment sheet, or in a different form are provided with a rubber-like carrier matrix. A first group of filaments comprises filaments that are oriented essentially transverse to the direction in which the belt runs, with these filaments being made of a material having a high strength, a high resistance to bending, and a high resistance to temperature. A second group of filaments is comprised of filaments that are oriented essentially in the direction in which the belt runs, with these filaments being made of a material that in contrast has a lower strength and/or lower resistance to temperature.

DE 102 03 015 A1 discloses a V belt that is provided with a load-carrying section of wound cords, with this belt being made of a thermoplastic elastomer and having provided below the load-carrying section a fabric support layer for supporting the load-carrying section during the manufacturing process. Provided as the fabric of the fabric support ply is an open linen weave having warp and weft threads that cross at right angles in a conventional manner. The warp threads of this fabric support layer extend in the running direction of the V belt, whereas the weft threads, which are oriented at right angles to the running direction of the belt, are open at both sides and, relative to the outermost warp threads, have lateral extensions that are deflected toward the wide side of the belt base at approximately right angles to the running direction of the V belt. This forms essentially lateral supports for the outermost cords of the load-carrying section. The threads that are oriented at right angles to the running direction of the belt, and have their ends deflected upwardly, end at a distance from the sides of the V belt. The warp threads and/or the weft threads are multi filament threads or yarns, or monofilament wires, of a temperature-resistant material, whereby they should have a temperature resistance of at least 250° C. Proposed in addition to wires of metal are wires or threads of polymeric material. Provided as warp threads and also as weft threads are threads of cotton or aramid. These materials should, at least during the manufacturing time period, withstand the temperatures of the melted elastomers. This group of threads, which has a lower resistance to temperature, thus essentially has the function of a bonding aid for the threads of the other group.

Power transmission belts are made of various flexible rubber-like materials. The materials that are used include rubber as well as other flexible materials, such as polymerizable polymers. Load carriers that are used are materials of polyester, polyamide, aramid, glass and others.

To achieve a transverse rigidity, reinforcing elements in the form of binding cord weaves are introduced into the belt matrix. These reinforcing elements generally comprise cords that are combined to form fabric. These cords comprise cabled or twisted individual elements, for example of polyamide or polyester, which in order to achieve a better binding to the matrix are provided with adhesive agents. In this connection, the cords are generally processed in the warp direction. The adhesive threads that extend in the weft direction are generally comprised of thin individual or twisted threads of cotton or synthetic fibers and mixtures thereof, since they merely serve to hold together the composite of the cord threads.

Binding weaves are generally used in V belts, predominantly in open-sided wide V belts in the form of up to eight or more fabric plies that are respectively placed upon a rubber-like embedment sheet to form double plies; this is intended to significantly increase the transverse stability of such wide V belts or ribbed V belts. This transverse stability is an important factor for fixing the load limit of a belt, and hence for its service life.

The conventional embodiments of binding weaves for standard use in V belts are generally based on the following construction. Used as warp threads, at a high warp density, are multi filament cord threads, primarily of polyamide, which for the purpose of providing a good adhesion with the elastomeric material are made rubber compatible by dipping in adhesive agent. This generally takes place after the weaving.

Used as weft threads are generally cotton threads or the like, having a low weft density, as a binding aid for the warp threads.

This weave is doubled with an embedment sheet of rubber, i.e. is provided in such a way that a composite of rubber and binding weave results. This composite is cut into plates or strips that for the manufacture of a belt are rotated by 90° and are again connected, so that the cord threads that previously extended in the longitudinal direction as warp threads are now disposed in the transverse direction to the rubber/binding cord composite. This composite layer, which is now transversely directed relative to the multi filament cord warp threads, is then wound as a multiple of layers onto a drum. The thereby resulting winding is unwound to form the load-carrying layer having load-carrying cord, and is provided with a cover layer. In this connection, the sequence load-carrying layer-cord layer can also be reversed. After the vulcanization of this uncured structure, individual rings are cut off that after further processing can be used as belts.

The above described process sequence during the manufacture of a belt has the drawback that for the weaving of the adhesive cord-weave layers, the cord threads are used as warp threads, since as a result, as described above, an additional process step of,transversely orienting by rotating about 90° is necessary. A further drawback is that as a measure for improving the bending resistance twisted or cabled cords are used, since the twisting and cabling of a fiber or filament like material increases the ability of the filament to bend.

It is an object of the present invention to embody a power transmission belt, in particular wide V belts or ribbed V belts, in such a way that on the one hand the manufacture thereof is simplified, and on the other hand the resistance to bending or transverse rigidity of the belt is improved.

### BRIEF DESCRIPTION OF THE DRAWING

This object, and other objects and advantages of the present invention, will appear more clearly from the following specification in conjunction with the accompanying drawing, in which:

the sole FIGURE is a cross-section of one exemplary embodiment of an inventive power transmission belt.

### SUMMARY OF THE INVENTION

The aforementioned object is realized in that the filaments that are oriented transverse to the running direction of the belt, and which are composed of a material having a high strength and relatively high resistance to temperature, form the weft filaments, and are preferably comprised of monofilaments having a high resistance to bending, while the filaments of the second group form the warp filaments of the fabric plies.

In this manner, the previously required operating step of transversely aligning the composite sheet, which is comprised of rubber-like embedment sheet and fabric ply, becomes unnecessary, whereby in addition the transverse rigidity (bending rigidity) of the belt is increased considerably.

The inventive concept is based upon the following measures: used as weft threads are monofilaments of polyamide (for example PA 6.6) or polyester or other raw materials having a high rigidity and high melting or softening temperature of greater than 200° C., whereby the filaments are preshrunk and preferably made rubber compatible, for example by dipping in RFL or pre-treating and stiffening with isocyanate to effect a good adhesion (RFL=resorcinol formaldehyde resin/latex solution). The thickness of the monofilaments is preferably in the range of about 0.4 to 1.2 mm (for example 0.45 to 0.9 mm); the warp filament density is preferably in the range of 10-15 filaments, preferably approximately 12 filaments, per centimeter; multi filament (RFL or similarly dipped) cord threads or yarns are also suitable for use as weft threads during the manufacture of the fabric plies if these cord filaments have only a twist that is low for cord.

The filaments that function as warp filaments serve as necessary binding aids, so that as low a warp density as possible is selected, for example in the range of 4 to 8, and preferably approximately 6, filaments/cm. These warp threads are oriented in the belt in the running direction thereof, and should not interfere with the operating performance nor the profile formation of the belt during the vulcanization process. On the other hand, the warp density should be high enough that the ability to be interwoven (base tension during the weaving process), or the further processing, i.e. the doubling on the rubber-like embedment shee,t is ensured. During the processing, namely vulcanization and possibly tooth or profile formation, the warp threads should tear, soften or melt at the higher temperatures that are used in connection therewith.

Thin monofilaments having a thickness of, for example, 0.1 to 0.3 mm, such as 0.2 mm, or spun threads, can be used as warp threads, whereby cotton threads or the like are, in principle, suitable. However, monofilaments or spun long fibers on a thermoplastic or low-melting duromeric or thermosetting base are preferred as warp filaments pursuant to the present invention.

Raw materials that pursuant to the present invention are considered for these melting or softening filaments are:
Polyolefins (for example polyethylene)
Polyvinyl chloride (for example having the commercial name Rhovyl)
Polyvinylidene chloride (preferably having the commercial name saran)
Polyamide 11 or Polyamide 12 (for example having the commercial name Rilsan)

The advantage of polyvinyl chloride, polyvinylidene chloride, and similar materials in V belt mixtures is the high compatability and partial bonding of these thermoplastics to the polymerizable polymer, for example polyurethane. Threads or monofilaments based on polymeric materials having a melting point or a glass temperature of up to 170° C. can be used as warp threads.

Further specific features of the present application will be described in detail subsequently.

### Description of Specific Embodiments

The sole FIGURE of the drawing is a cross-sectional view showing a V belt 1, the narrow side of which, in the direction in which the V belt runs, is provided with a toothing that is indicated by the dashed line 2, while the slanted sides of the belt merge into the slanted sides of this toothing. Disposed below-the load-carrying section 3 are a plurality, for example three, of fabric plies 4 that are respectively disposed on a rubber-like embedment sheet, and the weft threads of which are preferably monofilaments having a high resistance to bending and a high resistance to temperature, whereby their melting or softening temperature is greater than 200° C. The filaments that are oriented in the running direction of the belt and during the weaving of the fabric plies form the warp threads are threads or yarns having a lower strength and/or a lower resistance to temperature than do the weft filaments. A toothing on the upper side of the belt back is indicated by the dashed line 5.

The inventive method for producing a power transmission belt, especially a V belt, wide V belt or ribbed V belt, comprises using, as fabric plies, such fabric having weft filaments that comprise monofilaments having a high strength and high resistance to temperature.

In a modified embodiment of the invention, at least one rubber-like sheet can be used upon which the reinforcing elements, in the form of monofilaments or cord filaments, are placed individually or in groups, and which then, to improve the transverse rigidity during build-up of the belt, are embedded in the elastomeric belt material in such a way that these reinforcing elements are oriented transverse to the running direction of the belt.

The specification incorporates by reference the disclosure of German priority document 10 2004 021 524.3 filed May 3, 2004.

The present invention is, of course, in no way restricted to the specific disclosure of the specification and drawing, but also encompasses any modifications within the scope of the appended claims.

1. A power transmission belt of a elastomeric material, comprising:
a load-carrying section disposed in said elastomeric material; and
a plurality of fabric plies disposed in said elastomeric material, wherein each of said plies is disposed on a rubber type embedment sheet or is embedded in a rubber type matrix, wherein each of said plies is composed of filaments that cross in a woven type manner, wherein a first group of said filaments comprises filaments that are oriented essentially transverse to a running direction of said belt, form weft filaments of said fabric plies, and are comprised of a material having a high strength, a high resistance to bending and a relatively high resistance to temperature, and wherein a second group of said filaments comprises filaments that are oriented in said running direction of said belt, form warp filaments of said fabric plies, and are comprised of a material that in contrast to the material of said first group of filaments has a lower strength and a lower resistance to temperature.

2. A power transmission belt according to claim 1, wherein said filaments of said first group of filaments are monofilaments having a high resistance to bending.

3. A power transmission belt according to claim 2, wherein said monofilaments are comprised of polyamide, including PA 6.6, or polyester, or some other material having high strength and a melting or softening temperature of greater than 200° C.

4. A power transmission belt according to claim 2, wherein said monofilaments are preshrunk and are treated and strengthened.

5. A power transmission belt according to claim 4, wherein said monofilaments are treated and strengthened by dipping in RFL or with isocyanate.

6. A power transmission belt according to claim 4, wherein said monofilaments have a thickness in the range of from 0.45 to 0.9 mm.

7. A power transmission belt according to claim 1, wherein said filaments of said first group of filaments are multi filament cord threads having only a low twist and being made of cabled or twisted individual threads.

8. A power transmission belt according to claim 7, wherein said individual threads are made of polyamide or polyester.

9. A power transmission belt according to claim 7, wherein said multi filament cord threads are provided with an adhesive agent.

10. A power transmission belt according to claim 9, wherein said adhesive agent is provided by dipping in RFL.

11. A power transmission belt according to claim 1, wherein said weft filaments are woven with said warp filaments at a high weft density in the range of from 10 to 14 filaments, preferably approximately 12 filaments, per centimeter.

12. A power transmission belt according to claim 1, wherein said warp threads are woven with said weft threads at a warp density in the range of from 4-8 filaments, preferably about 6 filaments, per centimeter.

13. A power transmission belt according to claim 12, wherein said warp filaments are monofilaments having a thickness in the range of from 0.1 to 0.3 mm.

14. A power transmission belt according to claim 13, wherein said warp filaments are monofilaments or spun long fibers on a thermoplastic base.

15. A power transmission belt according to claim 14, wherein as raw material for said warp threads are materials selected from the group consisting of polyolefins, including polyethylene, polyvinyl chloride, polyvinylidene chloride, polyamide 11 and polyamide 12 (including those having the commercial name Rilsan).

16. A power transmission belt according to claim 1, wherein said belt is a power transmission band, a V belt, or a ribbed V belt.

17. A power transmission belt according to claim 16, wherein said belt is embodied as an open-sided V belt, and wherein ends of said warp filaments extends to outer sides of surfaces of said belt.

18. A power transmission belt according to claim 1, wherein eight or more fabric plies are provided.

19. A method of making the power transmission belt of claim 1, including the step of:
using for each fabric ply a fabric having weft threads of a material having high strength, high resistance to bending and a relatively high resistance to temperature, and having warp threads of a material that in contrast to the material of said weft threads has a lower strength and a lower resistance to temperature.

20. A method of making a power transmission belt, including the steps of:
providing elastomeric material; and
embedding in said elastomeric material, during the course of a vulcanization process, a load-carrying section and at least one ply of reinforcing elements that extend transverse to a running direction of said belt, wherein for each of said plies, in a preparation stage, prior to said embedding step, reinforcing elements are provided in the form of monofilaments or cord filaments having a low twist, and said filaments are placed individually or in groups on a rubber type carrier substance to form a composite element for embedment, in the form of at least one ply, in said elastomeric material.
